(19) United States
(12) Patent Application Publication
(10) Pub. No.: US 2015/0066171 A1
(43) Pub. Date: Mar. 5, 2015

(54) OBSERVATION AND/OR OPERATION OF A SPORT AND/OR REHABILITATION DEVICE

(71) Applicant: SIEMENS AKTIENGESELLSCHAFT, Munich (DE)

(72) Inventors: Ingo Brussog, Sachsenheim (DE); Michael Wittkowski, Telgte (DE)

(73) Assignee: SIEMENS AKTIENGESELLSCHAFT, Munich (DE)

(21) Appl. No.: 14/389,147

(22) PCT Filed: Mar. 19, 2013
(86) PCT No.: PCT/EP2013/055664

§ 371 Date: Sep. 29, 2014

Related U.S. Application Data
(60) Provisional application No. 61/617,236, filed on Mar. 29, 2012.

(30) Foreign Application Priority Data
Mar. 29, 2012 (DE) 10 2012 205 162.7

(51) Int. Cl. G05B 24/02; A63B 22/00; G06F 19/00

(52) U.S. Cl. CPC G05B 24/02; G06F 19/3481; A63B 22/00; A63B 2220/833
USPC 700/91

(57) ABSTRACT

A method for observation and/or operation of a sport and/or rehabilitation device uses open-loop and/or closed-loop control of the device. A smartphone, navigation device, digital picture frames or a tablet PC is used as the Human Machine Interface (HMI). The HMI and the sport and/or rehabilitation device connect to one another via a communication connection. The HMI and the sport and/or rehabilitation device identify each other mutually. The sport and/or rehabilitation device checks the HMI for its suitability for observation and/or operation. In the event of the HMI being suitable for observation and/or operation of the sport and/or rehabilitation device, an application is started at the HMI for observation and/or operation of the sport and/or rehabilitation device. In the event of the HMI not being suitable for observation and/or operation of the sport and/or rehabilitation device, a signal is output.

### CROSS REFERENCE TO RELATED APPLICATIONS

This application is based on and hereby claims priority to International Application No. PCT/EP2013/055664 filed on Mar. 19, 2013, German Application No. 10 2012 205 162.7 filed on Mar. 29, 2012, and the U.S. Provisional Application No. 61/617,236 filed Mar. 29, 2012, the contents of which are hereby incorporated by reference.

### BACKGROUND

The invention relates to a method for observation and/or operation of a sport and/or rehabilitation device and also to open-loop and/or closed-loop control of a corresponding device. The invention further relates to a program and an application for carrying out the method.

Current open-loop and closed-loop control electronics is equipped with high-quality HMI components, extending right up to high-resolution touch displays with video capabilities (HMI=Human Machine Interface, also MMI=Man Machine Interface). This leads not infrequently to a sharp increase in price of the necessary components, on the other hand there are sufficient applications in which HMI is only used from time to time, for example for the occasional checking of measured values and setting values or for occasional entry of new parameters. This is particularly true for example for sport and/or rehabilitation devices from the home area such as ergometers, electric-motor-driven treadmills and similar training devices, which are frequently out of operation for a majority of their available time, so that the sometimes very high-quality HMI components are largely unused and lie “fallow”. Previously the high-quality HMIs have been permanently connected to the open-loop and closed-loop control electronics and are thus also absolutely vital for their operation.

### SUMMARY

One possible object is to specify a low-cost solution for observation and/or operation of a sport and/or rehabilitation device.

The inventors propose a method for observation and/or operation of a sport and/or rehabilitation device having closed-loop and/or open-loop control with an HMI, wherein a device from the class smartphones, navigation devices, digital picture frames and tablet PCs is used as the HMI, wherein the HMI and the sport and/or rehabilitation device are connected to each other via a communication connection, wherein the HMI and the sport and/or rehabilitation device identify one another, wherein the sport and/or rehabilitation device checks the HMI for its suitability for observation and/or operation and wherein, in the event of the HMI being suitable for the observation and/or operation of the sport and/or rehabilitation device, an application for observation and/or operation of the sport and/or rehabilitation device is started on the HMI, and in the event of the HMI not being suitable for observation and/or operation of the sport and/or rehabilitation device, a signal is output.

If the technical properties of a modern sophisticated HMI of equally modern open-loop and closed-loop electronics of a sport and/or rehabilitation are examined more closely, it can be seen that they have much in common with the service features for so-called smartphones, modern mobile navigation devices or high-quality “digital picture frames” with touch input facilities as well as with the so-called tablet PCs which are also currently emerging. The solution creates an interface at the described open-loop and closed-loop electronics, via which one of the devices, which might be “available in any event” from the class smartphones, navigation devices, digital picture frames or tablet PCs can be used as an HMI.

In accordance with the proposal the (if necessary “embedded”) open-loop and/or closed-loop control of a sport and/or rehabilitation device, which does not need any permanent use of a high-quality HMI, is equipped with one (or a number of equivalent) additional interface (s), so that, in the event of an interaction via HMI by the user, their smartphone, satnav, digital picture frame with touch input facility or tablet PC can be used for precisely this interaction. These devices can also be referred to below by the simple generic term “communicator”. The previously mentioned mobile devices/communicators in accordance with the current related art, have one or more radio or optical interfaces for wireless communication. WLAN, Zig-Bee, Bluetooth, GSM in all its versions, as well as infrared light could be mentioned here by way of example. Communicators in accordance with the related art also generally have wired interfaces—USB can be mentioned here is an example—so that they can be connected equally well by an adapter cable.

For the (complete) use of one or more of the communicators previously mentioned it is also necessary to qualify a selection of devices which are actually in a position to communicate via the new interface (s) with the (if necessary “embedded”) open-loop and/or closed-loop control. After the (mutual) identification, the HMI is therefore checked for its suitability, which for example can be undertaken on the basis of a list stored in the sport and/or rehabilitation device or on the basis of interrogated service features of the communicator. For these reference devices or service features as well as for the open-loop and/or closed-loop control concerned, which in addition must also have at least one new interface for communication with the communicators, an application (i.e. application software) is provided, which simulates the presentation of the open-loop and/or closed-loop control-specific HMI on the communicator and makes the observation and/or operation of the sport and/or rehabilitation device possible.

If on the other hand the HMI is not suitable for observation and/or operation of the sport and/or rehabilitation device, a signal is output, so that a user of the communicator recognizes that operation and/or observation of the sport and/or rehabilitation device is not possible for them. The signal can for example involve an acoustic, optical or haptic signal. The signal can be output at the HMI itself or outside the HMI, e.g. at the sport and/or rehabilitation device.

The solution advantageously enables the customer or user of an “embedded” open-loop and/or closed-loop control of a sport and/or rehabilitation device, preferably in the home area, but also in the professional area, to be provided with a low-cost solution which they merely have to supplement by communication equipment which is present in any event. The presence of very high-end properties in current communicators, such as multitouch capability for example, presentation of high-resolution videos, localization via GPS or comparable techniques, provide opportunities for modern service features from the commercial area to be ported at very low cost into fitness applications for example.

A “sport device” or a “rehabilitation device” is to be understood in very general terms as a device for sport or rehabilitation purposes, wherein this includes such devices as fitness devices, training devices or exercise machines (e.g. ergometer, cross trainers, treadmills, rowing devices or multi-gyms).

Preferably the sport and/or rehabilitation device has a drive, especially advantageously an electrical drive (i.e. the device involved is a device driven by an electric motor), and the open-loop and/or closed-loop control is used for open-loop and/or closed-loop control of the drive. In addition to an electrical drive however other forms of drive such as e.g. a pneumatic drive are possible. With the drive real situations can be emulated for the user of the device in which the drive generates mechanical forces which act directly or indirectly on the user of the device. The device can thus be viewed as a “simulator” of these real situations for sport and/or rehabilitation purposes (e.g. as a “rowing simulator”).

The open-loop and/or closed-loop control preferably involves an electronic (if necessary embedded) open-loop and/or closed-loop control.

The communication connection can be established especially simply through a separate communication application at the HMI. Two-stage starting of the operation and observation is then possible. In a first stage the (mostly hardware-dependent) communication basis is enabled and only in a second stage is the actual application for observation and/or operation started. The latter can then be embodied as a pure software solution and thus independently of the actual hardware and thus be used for a plurality of different communicators on the hardware side. Naturally the communication application and the application for observation and operation can also be combined into a single application.

The application for observation and/or operation of the sport and/or rehabilitation and/or the communication application can advantageously be transmitted from the sport and/or rehabilitation device, from a separate memory or over a network such as the Internet via a download to the HMI. In an especially advantageous transmission from the sport and/or rehabilitation device to the HMI, incompatibilities, and malfunctions resulting therefrom can especially be avoided. In addition it relieves the user of the tedious necessity of providing the application themselves in advance, for example through a download from the Web page of the manufacturer of the sport and/or rehabilitation device or from a specific website for applications which are released for specific communicators. In such cases, there can also be transmission of a number of device-specific applications or they can be provided to the user for selection at the HMI, which for example fulfill different functionalities. In this sense, in general terms the “application for observation and/or operation” can so to speak include a number of (individual) applications or “application modules.”

In an especially advantageous embodiment the sport and/or rehabilitation device checks the HMI or its user for their authorization for observation and/or operation. For this purpose at least one item of information about authorization can be interrogated by the sport and/or rehabilitation device from the HMI. This information can be transmitted by the HMI automatically for example as part of the identification, or the authorization can for example be undertaken with the start of the application in the form of a password request. Naturally the diversity of options of modern communicators means that the widest variety of security levels is conceivable and able to be implemented, such as a voice pattern comparison for example. Also conceivable here is a time-limited authorization, through which for example users can be notified of a password in a fitness center, through which they can use a sport and/or rehabilitation device for example for 1 hour with their intelligent communicator as HMI.

Especially advantageously the authorization can be provided by a previously parameterized “hardware dongle” (hardware key), which is connected to the (if necessary embedded) control or to the HMI. This “hardware dongle” can be available for example in the form of a specially encoded USB memory stick or a coded SD/ySD memory card. Communication between the sport and/or rehabilitation device and a communicator is then for example only enabled if this hardware dongle is present and is in operation. The information requested by the communicator can then contain a code which is compared to codes stored in the sport and/or rehabilitation device or on the hardware dongle and the communication connection is only set up or the application is only started if the result of this comparison is positive.

As an alternative and/or in addition the authorization can also be undertaken through a software link on the (if necessary embedded) open-loop and/or closed-loop control, which has been individually programmed/parameterized during the manufacturing of the open-loop and/or closed-loop control into the open-loop and/or closed-loop control and has been made known to authorized communicators. The parameterization can also be undertaken retrospectively via value-added services via a gateway of the open-loop and/or closed-loop control and a network such as the Internet for example.

The result of the checking of the authorization can subsequently be output at the HMI by an acoustic or optical signal.

In accordance with an especially advantageous embodiment, before the communication connection is established, the HMI contacts a number of sport and/or rehabilitation devices and is only connected to one sport and/or rehabilitation device via a communication connection if the sport and/or rehabilitation device has logged on at the HMI in response to this contact. It can then be deduced for those sport and/or rehabilitation devices which have not logged on that these are either inactive, not authorized, defective or already in use by other users or communicators. Users can then save themselves unnecessary attempts at establishing a communication connection to these sport and/or rehabilitation devices and thus save time and money.

In a further advantageous embodiment location data is transmitted from the HMI to the device. In such cases a mobile navigation device can be used as a communicator for example which has previously recorded in an excursion the real data of a route (or cycle route) via GPS and now passes this on to the control in its HMI functionality as a “realistic simulation” in the form of dynamically changing parameters. Thus with the use of the communicator with navigation functionality, its location data or already stored location data can be used to simulate real routes. A further example of this would be cycling the route of the Tour de France or of a route that you have travelled yourself on the ergometer with “live GPS” and associated (force) parameter data by using the recorded data records, right through to edited-in video recordings.

In a further advantageous embodiment the HMI is used by at least one further communication connection as a gateway for the sport and/or rehabilitation device. Through this option of gateway functionalities, into the Internet for example, built into many current communicators, remote processes such as remote maintenance, remote monitoring, central data logging, software updates etc. can be realized. Remote monitoring can on the one hand relate to data of the sport and/or rehabilitation device itself, but also to data of the user of the sport and/or rehabilitation device. Thus for example a pulse rate or blood pressure of the user can be detected by sensors connected to the sport and/or rehabilitation device and be transmitted to the HMI together with data of the sport and/or rehabilitation device such as e.g. speed, journey time, ramp functions and be transmitted by the gateway to a central monitoring location or to a rehab clinic, which uses the sport and/or rehabilitation device for example as part of the rehabilitation program and through this monitors and evaluates correct compliance with the requirements of the hospital and/or of the clinic in respect of the use of the sport and/or rehabilitation device by a patient and on the other hand the bodily state of the patient, in order to follow the rehabilitation progress of the patient and avoid damage to the patient's body. By a data transmission from the central monitoring points to the HMI, requirements can again be set for the patient for their rehabilitation program and evaluations of their exercise results can be made available. In such cases control data for the drive of the sport and/or rehabilitation device received from the central location can be forwarded by the HMI to the sport and/or rehabilitation device and processed in the control of the sport and/or rehabilitation device, converted into control signals for regulation of the drive and be output at the drive of the sport and/or rehabilitation device. The central monitoring points can thus serve as a higher-ranking user-specific control for the sport and/or rehabilitation device. The sport and/or rehabilitation device and the patient in such cases do not have to be in the hospital or in the rehabilitation clinic but can be removed from these locations and can for example be located in a fitness centre or in the patient's house.

In a similar manner, as part of a training program, through the transmission of performance data of the sport and/or rehabilitation device and of the user to a central location, a sports person can be monitored and evaluated for adherence to requirements of the training program and with regard to the physical state of the sports person. By a data transmission from the central location to the HMI the sports person can in their turn be given requirements for the training and evaluations of their training results can be made available. Here too control data for the drive of the sport and/or rehabilitation device received from the central location can be forwarded by the HMI to the sport and/or rehabilitation device and processed in the control of the sport and/or rehabilitation device, converted into control signals for drive control and output to the control of the sport and/or rehabilitation device. The sport and/or rehabilitation device can thus be controlled at a higher level from a central training location for a specific user. The sports person can in such cases be located remotely from the central location, e.g. at their home or in a fitness center.

In a further advantageous embodiment, value-added services of a commercial provider are used by the gateway. This enables “payment applications” of a provider to be used, implemented and automatically billed via the intelligent communicator for example. But parameter sets which are simply of interest (for example location data) can also be obtained for simulation purposes.

In a further advantageous embodiment, preferably via a gateway, a communication connection with a least one further sport and/or rehabilitation device, preferably of the same type, or a further HMI for observation and/or operation of a further sport and/or rehabilitation device can be set up and data is sent and/or received. In this way the sport and/or rehabilitation device—for example an electronic control device of the sport and/or rehabilitation device—can establish contact with other sport and/or rehabilitation devices and their communicators and have joint events take place such as for example a “live competition on ergometers.”

Preferably the at least two sport and/or rehabilitation devices in such cases are differentiated by the HMI through unique addressing. In this way one and the same communicator can be used as a high-quality HMI for a number of independent open-loop and/or closed-loop controls, through which, as well as a saving in HMIs, a greater convenience is also achieved, wherein similar open-loop and/or closed-loop controls can also be controlled in the same way in application or different open-loop and/or closed-loop controls can also be controlled through different applications if necessary.

In a further advantageous embodiment in such cases a benchmark of the at least two sport and/or rehabilitation devices can be performed. This enables data of the open-loop control (s) and/or closed-loop control (s) to be benchmarked. Parameter sets of paid services can also be obtained simultaneously by a number of devices, which then “appear against one another” in a benchmarking, wherein the results of this benchmarking can optionally again be copied back to a central memory for future use.

The HMI can also assume what is known as a “master-slave mode” with a number of sport and/or rehabilitation devices or their assigned communicators, in which operating mode a communicator (either automatically—e.g. the first one put into operation—or an allocated communicator) assumes the master function and via one of its communication interfaces collects the data of all other slave communicators from the network and also distributes it again, in order in this way for example to make benchmarking possible in direct operation without additional intermediate servers and without the need for Internet access (island mode). This is especially advantageously possible via wireless communication if the sport and/or rehabilitation devices are located for example in the immediate vicinity of one another or in the same radio field.

It is also possible in such cases for one of the sport and/or rehabilitation devices to assume the role of the master. The sport and/or rehabilitation device which assumes the role of the master, can then—for example in response to activation of the communicator 1 currently connected to it—communicate a search function, in order to search for further communicators to be considered. These are then offered for selection as benchmark participants to all other communicators. After an activation, the further communicators which store current training data and which interrogate the others, can communicate with the master. Thus each communicator has access to the current training data of the benchmark participants.

In a further advantageous embodiment, at pre-determinable times at least one item of information relating to the sport and/or rehabilitation device is displayed. This presents the opportunity of using a communicator connected to the device largely for other purposes and only of visualizing significant events relevant for the electronic control device (meaning the sport and/or rehabilitation device) in temporally predetermined short time slots and if necessary waiting for an acknowledgement entry. Thus for example a digital picture frame can display images stored within it for 99% of its active time and merely show the operating states of a sport and/or rehabilitation device communicating with it for 1% of its active time.

In a further advantageous embodiment, for a critical state of the sport and/or rehabilitation device or of a user of the sport and/or rehabilitation device, an optical and/or acoustic warning signal can be output at the HMI. By this a user is immediately alerted to the presence of an “alarm” or “emergency” and can thus initiate countermeasures in good time. This automatic warning message likewise enables the corresponding communicator to be largely used for other purposes.

Especially advantageously the HMI is also supplied by the sport and/or rehabilitation device with electrical energy. In such cases, in addition to wired energy supply, inductive energy supply or other forms of transmission are also conceivable. This enables the operability of the HMI to be maintained even when it is used for longer periods.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows one example of the proposed method, using the operation of a treadmill as an example,

FIG. 2 shows an application of the method within the framework of a fitness device system,

FIG. 3 shows an example of the method execution sequence for a local control of a fitness device and

FIG. 4 shows an example of the method execution sequence for a central control of a fitness device.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

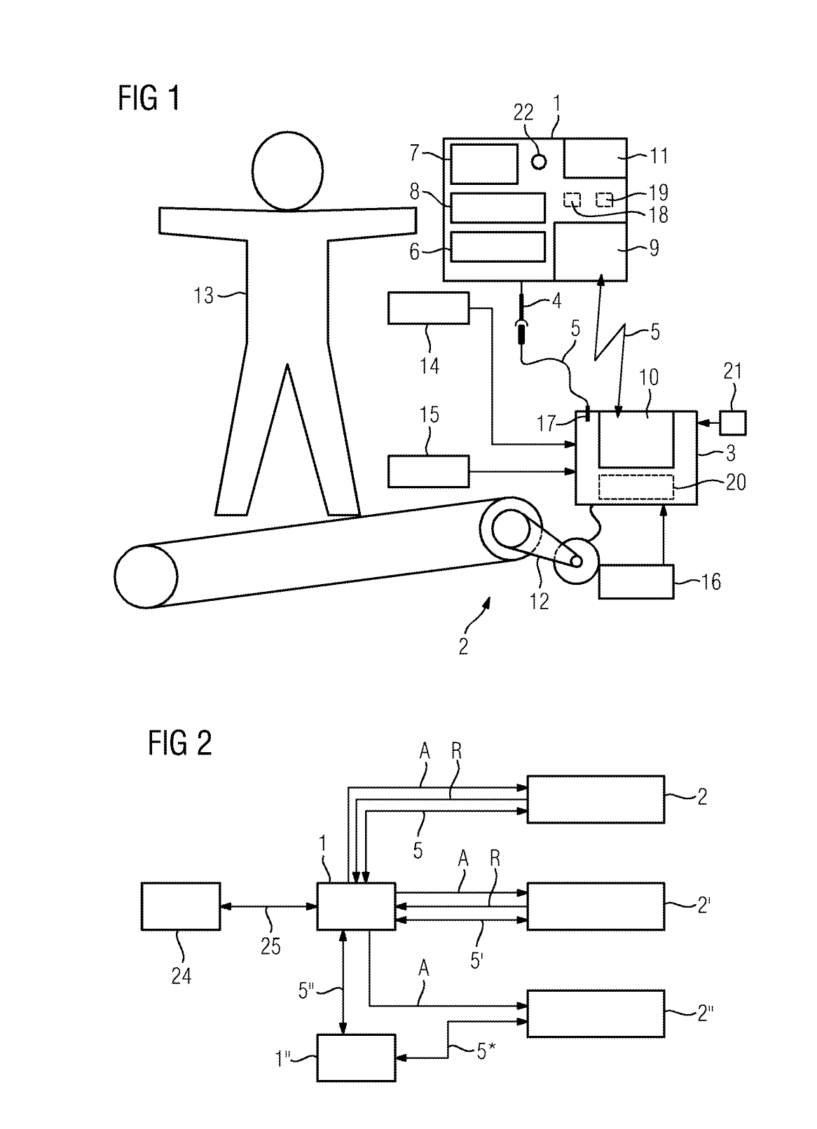

FIG. 1 shows a Man or Human Machine Interface 1 (MMI or HMI) for a sport and/or rehabilitation device in the form of a fitness device 2, for which a treadmill with an embedded control 3 has been selected as an illustration. A device from one of the classes smartphones, navigation devices, digital picture frames and tablet PCs is used as the HMI 1, which has its own microcontroller (processor) 6, on which the applications 18 and 19 run. The treadmill 2 is moved by an electronic drive 12. Via corresponding menus and input functions in the HMI 1 the user 13 can now enter values such as speed, running time, ramp functions etc. In the control 3 these entries are processed by a control program 20 and converted into control signals for the drive and output to the drive 12. At the same time via various sensors—like for example a sensor 14 for the pulse rate, a sensor 15 for the position of the user 13 and a sensor 16 for the speed—input parameters such as for example the pulse of the subject, force effect on the treadmill, exceeding of safety limits etc. are constantly read in and processed by the control program 20 in real-time together with the input functions, in order in their turn to have an influence on the output data to the drive 12.

In the sense of this document an existing “communicator” is used as HMI 1, which is connected via a communication device 9 via a corresponding communication device 10 of the embedded control 3 with this selfsame unit. An application 19 (App) runs on the communicator 1, which now fully takes over the HMI function for the control 3 and therefore will also be referred to below as the HMI application. Through the application 19, on the communicator 1 connected to the device 2, parameterization processes, control interventions, check outputs and visualizations can be carried out. As an option this application 19 can also be transferred first of all from the control 3 to the communicator 1 in order to avoid incompatibilities, and malfunctions resulting therefrom.

If the communicator 1 possesses a number of communication interfaces 4, it can at the same time serve as a gateway, for example in order on the one hand to communicate via Bluetooth with the control and on the other hand via GSM/GPRS to make possible for example remote access for service technicians, a central monitoring and evaluation of data of the fitness device or of its user and likewise parameterization processes, control interventions, check outputs and visualizations.

An input element 8, in the form of a keyboard for example, is available at the communicator 1 for the input of data. If the display 7 involved is a touch screen, this input element 8 can also be integrated into the display 7.

In another example the communicator 1 can be a mobile navigation device which has previously, in an excursion for example, recorded the real data of a route via GPS and now passes on said data in its HMI functionality as a “realistic simulation” in the form of dynamically changing parameters to the embedded control 3.

For playing multimedia files (for example for following a simulated route), or also the output of optical signals and acoustic signals (e.g. of an alarm signal) the communicator 1, as well as a display 7, also features at least one loudspeaker 11. The interface 4 for communication with the control 3 can in this case be embodied for a communication connection 5 by cabling as shown or naturally wirelessly (radio, optical). The control 3 for this purpose likewise has the corresponding, and by comparison with previous controls for similar devices, additional interface 17.

The communicator 1 can also be supplied with electrical energy by the fitness device 2 via further interfaces or via the wired interfaces 4 and 17.

A communication application 18 also runs on the communicator 1 for establishing the communication connection 5, wherein the communication application 18 can also be combined with the HMI application 19 into a single application. The communication application 18 is typically hardware-dependent, i.e. dependent on the hardware of the communicator 1. While the application 19 is independent of the hardware of the communicator 1.

The display 7 is also used for output of an optical signal if the result of a check is that the HMI 1 is not suitable for observation and/or operation of the fitness device 2 and/or the HMI 1 or its user is not authorized for this. As an alternative or in addition this can also be done by the output of an acoustic signal on the loudspeaker 11. As an alternative or in addition, corresponding signals can also be output on the fitness device 2 or at other output units not shown in any greater detail.

The data of the fitness device 2 or data of its user recorded by the control 3, such as for example the pulse rate, the position of the user 13, the speed, is transmitted via the communication connection 5 to the HMI 1 and evaluated there by the application 19 and displayed together with the results of the evaluations on the display 7.

In such cases the application 19 compares the data detected by the control 3 with threshold values for a critical state of the fitness device 2 or of the user 13 of the fitness device, preferably dependent on the user, and outputs an optical warning signal on the display 7 or an acoustic warning signal on the loudspeaker 11 if these threshold values are exceeded upwards or downwards.

Pictures of the user on the fitness device 2 can also be recorded via a video camera 22 integrated into the HMI and—if necessary together with other data of the fitness device 2 or its user recorded by the control 3 or the communicator 1—can be sent to other communicators or to a central location.

In addition the results of a benchmark with other users can be displayed by the HMI application 19 on the display 7 (for example in real-time), if necessary together with pictures of the respective user recorded by the respective video camera 22.

For checking an authorization of the communicator 1 or of its user 13 the control 3 is connected to a parameterizable hardware dongle (hardware key) 21. This hardware dongle 21 can be available for example in the form of a specially-encoded USB memory stick or of an encoded SD/uSD memory card. The communication connection 5 between the fitness device 2 and the communicator 1 is then for example only enabled if this hardware dongle 21 is present and is in operation. The information requested by the communicator 1 can then for example contain a key, which is compared in the control 3 with the key or keys stored on the hardware dongle 21 and the communication connection 5 is only set up by the communication application or the application 19 is only started if the result of this comparison is positive.

As an alternative or in addition the authorization can also be undertaken by a hardware dongle connected to the communicator 1 or by a software link to the (if necessary embedded) open-loop and/or closed-loop control 3, which is individually programmed/parameterized into the control during the manufacturing of the control and is made known to authorized communicators. The parameterization can also be undertaken retroactively for example via value added services, via a gateway of the control 3 and a network such as the Internet for example.

FIG. 2 shows a fitness device system with a number fitness devices 2, 2′, 2″, as described in conjunction with FIG. 1. The fitness devices 2, 2′, 2″ are controlled, monitored and/or evaluated via a communicator 1 which, as was described in conjunction with FIG. 1, serves for operation and/or observation of one or more of the fitness devices 2, 2′, 2″.

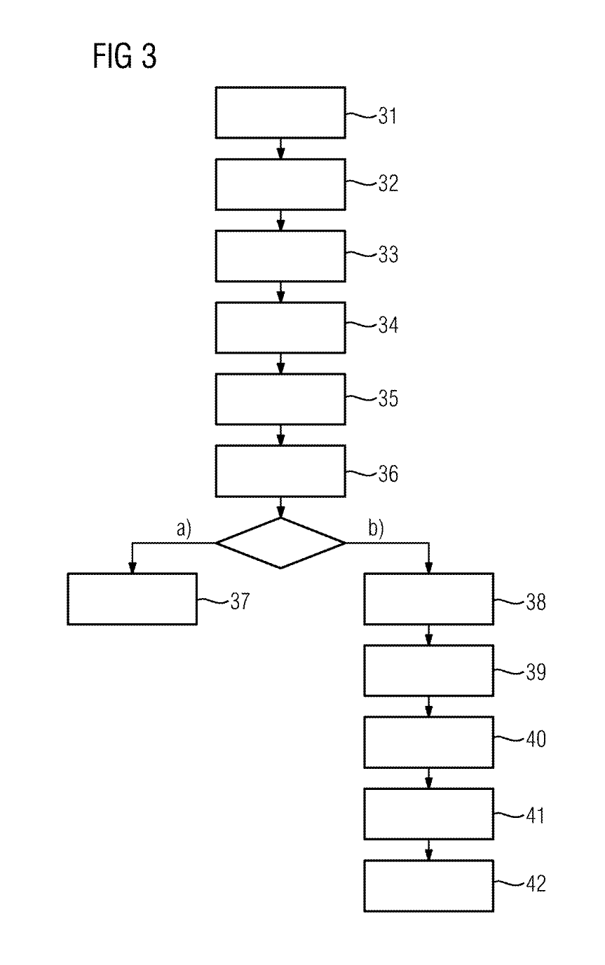

To this end FIG. 3 shows an example of the method execution sequence for a local control of a fitness device.

In a first box 31, for initial use of the communicator 1 for operation and/or observation of the fitness devices 2, 2′, 2″, the communication application 18 and the HMI application 19 are to be installed on the communicator 1 (e.g. by a download from the Internet).

In a second box 32 the communication application 18 is started on the communicator by a user and said communicator now contacts all fitness devices 2, 2′, 2″ via a request A. One or more of the fitness devices 2, 2′, 2″, here for example the fitness devices 2 and 2′, respond to this request in a box 33 with a response R.

The communication application 18 now prompts the user 13 in box 34 by the display 7 to select one of the fitness devices which has responded.

For the fitness device selected by the user 13 by the input element 8, here the fitness device 2, the communication application 18 in a box 35 now establishes a communication connection 5 with the control 3 of the fitness device 2.

Via this communication connection 4, in a box 36 the communicator 1 and the fitness device 2 or its control 3 now identify themselves to each other and the control 3 checks the communicator 1 for its suitability for observation and/or operation.

In the event a) of the communicator 1 not being suitable for observation and/or operation of the fitness device 2, an acoustic or optical signal is output by the communication application 18 in a box 37 on the communicator 1 or via the control 3 on the fitness device 2.

In the event b) of the communicator 1 being suitable on the other hand for observation and/or operation of the fitness device 2, the HMI application 19 for observation and/or operation of the fitness device 2 is started on the communicator 1 in a box 38 by the communication application 18.

After the box 38, in a box 39, a password is requested by the HMI application 19 from the user 13, this password is transmitted to the control 3 and is compared there by the control program 20 with passwords which are stored on the hardware dongle 21.

Only if the comparison is positive is the user 13 requested in a box 40 by the HMI application 19 to enter values such as speed, running time, RAM functions. The values entered by the user 13 by the input element 8 into the communicator 1 are recorded by the HMI application 19 and sent via the communication connection 5 to the control 3, where they are used for control of the drive 12.

Conversely data recorded by the control 3 about the fitness device 2 or about its user 13, such as pulse rate, speed, for example, is transmitted by the communication connection 5 to the communicator 1 and is output there by the HMI application 19 on the display 7. In addition the received data is monitored by the HMI application by comparison with threshold values which indicate a critical state of the fitness device 2 or of the user 13 of the fitness device 2 and if the values exceed/fall below the threshold values, an optical and/or acoustic warning signal is output on the communicator 1.

In the box 40 data of the user 13 of the communicator 1 (e.g. height, age, weight, physical capabilities, state of health, former therapy) can also be interrogated by the HMI application 19 via the display 7 and the input element 8 and from this for example the values for controlling the drive 12 such as speed, running time, ramp functions and also the threshold values which indicate a critical state of the fitness device 2 or of the user 13 of the fitness device 2, can also be determined by the HMI application 19.

In a box 41—if necessary also at a later time—in a similar manner to that described above for the fitness device 2—a communication connection 5′ can be established by the communicator 1 with fitness device 2′, wherein the two devices 2, 2′ are distinguished by a unique addressing by the communicator 1.

As an alternative or in addition the communicator 1 can also establish a communication connection with another communicator 1″ for observation and/or operation of another fitness device. For example the communicator 1 establishes a communication connection 5″ with a communicator 1″ for observation and/or operation of the fitness device 2″. The communicator 1″ is in its turn connected via a communication connection 5* to the fitness device 2″.

Via the communication connections 5, 5″ a benchmark of the two fitness devices 2, 2″, e.g. in respect of pulse rate, speed, running time etc. can be carried out by the HMI application 19 in a box 42 and the results can be output on the display 7 of the communicator 1. The HMI application 19 requests the data required for this purpose from the two fitness devices 2, 2″.

In such cases a “master-slave operation” is also possible in which operating mode one of the available communicators (either automatically—e.g. the first communicator put into operation or an allocated communicator) assumes the master function and collects the data of the other slave communicators by one of its communication interfaces and also distributes again, in order in this way for example to make possible benchmarking without additional intermediate servers and without the need for Internet access (island mode) in direct operation. This is especially advantageously possible via wireless communication, if the fitness devices 2, 2′, 2″ are located for example in the immediate vicinity of one another or in the same radio field.

It is also possible in this case for one of the fitness devices 2, 2′, 2″ to assume the role of the master. The fitness device 2, 2′, 2″, which assumes the role of the master communicates a search function in response to the activation of the current communicator connected to it in order to look for further possible communicators. These are then offered for selection as benchmark participants to all communicators connected to the system. After an activation the further communicators can communicate with the master, store the current training data and request that of the others. Thus each communicator has access to the current training data of the benchmark participants.

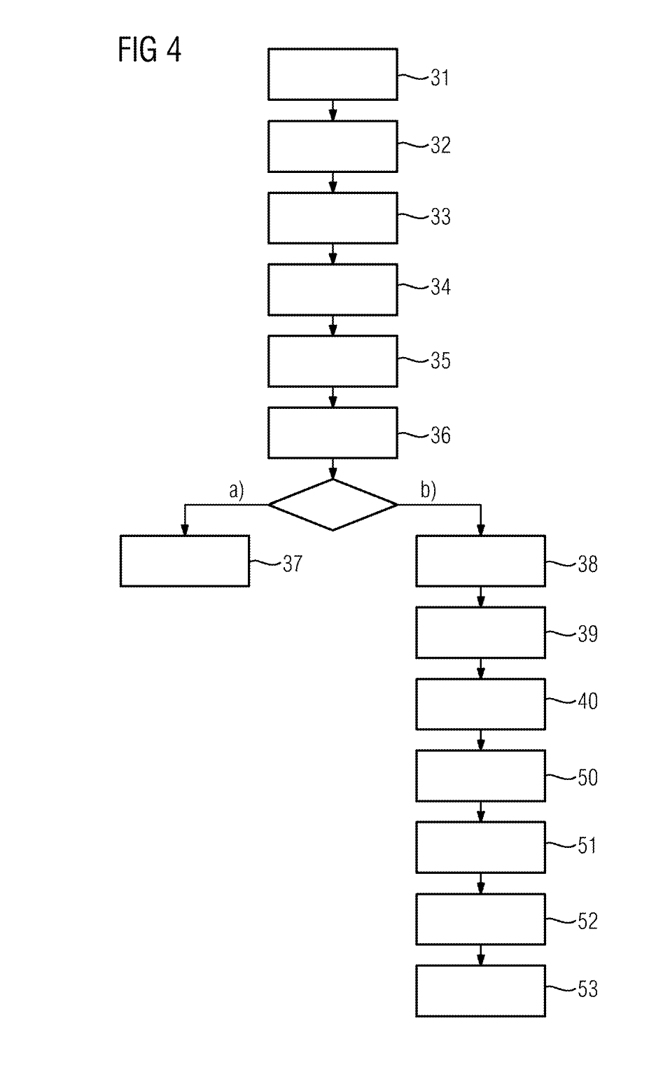

For an example of a method execution sequence for a central superordinate control of a fitness device shown in FIG. 4 the fitness device system of FIG. 2 additionally also has a central control, monitoring and/or evaluation unit 24. In this case following on from the box 40 of FIG. 3 a communication connection 25 is established by the HMI application 19 in a box 50 to the central control, monitoring and/or evaluation unit 24. The central control, monitoring and/or evaluation unit 24 can be located remotely from the fitness devices 2, 2′, 2″, for example on the site of a hospital, a rehabilitation facility or training center, and the communication connection 25 can be made entirely or partly via the Internet. It can however also be located locally at the fitness devices 2, 2′, 2″ and the communication connection 25 can then be made for example as a wireless or wired connection via a local network such as an intranet for example. The central control, monitoring and/or evaluation unit 24 can also be located in one of the fitness devices 2, 2′, 2″ and can be connected wirelessly or by wire to the communicator 1 (also to all further communicators) in a communication connection.

In a box 51 location data and control data for the drive of the fitness device 2, such as speed, run duration, ramp functions etc., are requested by the HMI application 19 from the central unit 24 and on the basis of this request are transferred from the central unit 24 to the communicator 1.

The location data and control data obtained from the central unit 24 are subsequently transmitted in a box 52 from the HMI application 19 via the communication connection 5 to the control 3, are processed by the control 3 or the program 20 and are converted into control signals for the drive regulation and output to the drive 12. Higher-ranking control of the fitness device 2 is thus carried out by the central unit 24.

In a box 53 data about the fitness device 2 or its user 13 recorded by the control 3, such as e.g. pulse rate, speed running time, is transmitted via the communication connection 5 to the communicator 1, is output there by the HMI application 19 on the display 7 and is also transmitted onwards over the communication connection 25 to the central unit 24. In the central unit 24 the received data is monitored by a comparison with threshold values, which indicate a critical state of the fitness device 2 or of the user 13 of the fitness device 2, and if the values exceed/fall below the threshold values, a message is sent to the HMI application 19 on the communicator 1 which generates the output of an optical and/or acoustic warning signal on the communicator 1 by the HMI application 19. In addition the received data is stored in the central unit 24 and is thus available for further evaluations, such as benchmarks for example, with other fitness devices or for a comparison with data about previous usage of the fitness device 2 by the same users, e.g. for an analysis of training progress, the success of rehabilitation measures etc.

This type of remote monitoring, remote analysis and remote control enables the correct compliance with conditions of a hospital, a rehabilitation clinic or a training center for example in respect of the use of the fitness device 2 by a patient or sports person on the one hand and on the other hand, the physical state of the patient to be monitored and analyzed remotely. In addition, on the basis of the received and evaluated data, the control of the drive 12 of the fitness device 2 can be adapted practically in real-time remotely to the respective state of health or training progress of the user of the fitness device 2. A patient can be provided with evaluations of their state of recovery and a sports person with evaluations about their training progress and these can be output by the HMI application 19 on the display 7 of the communicator 1.

In such cases a synchronization of local data stored in the control 3 with data stored centrally in the unit 24 by the HMI application 19 is also possible (for example old training data can be transmitted to the currently used fitness device 2, utilized and if necessary stored in the central unit 24 again).

In the exemplary embodiments the proposals have been explained with reference to the fitness device in the form of a treadmill. This should not however be viewed as restricting. The circumstances explained in the exemplary embodiments apply equally to other sport and/or rehabilitation devices.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-16. (canceled)

17. A method for observing and/or operating sport and/or rehabilitation devices, having an open-loop control and/or a closed-loop control, comprising:
connecting a Human Machine Interface (HMI) and a first sport and/or rehabilitation device to one another, the HMI being a device selected from the group consisting of smartphones, navigation devices, digital picture frames and tablet personal computers, the HMI and the first sport and/or rehabilitation device being connected to one another via a first communication connection;
identifying the HMI at the first sport and/or rehabilitation device and identifying the first sport and/or rehabilitation device at the HMI;
checking, by the first sport and/or rehabilitation device, whether the HMI is suitable for observation and/or operation of the first sport and/or rehabilitation device;
if the HMI is suitable for observation and/or operation of the first sport and/or rehabilitation device, starting an application for observation and/or operation of the first sport and/or rehabilitation device on the HMI;
setting up a second communication connection from the HMI to a second sport and/or rehabilitation device for observation and/or operation of the second sport and/or rehabilitation device, the second communication connection being directly from the HMI to the second sport and/or rehabilitation device or indirectly from the HMI to the second sport and/or rehabilitation device via a further HMI assigned to the second sport and/or rehabilitation device;
sending and/or receiving data via the second communication connection and performing a benchmark comparison between the first and second sport and/or rehabilitation devices; and
if the HMI is not being suitable for observation and/or operation of the first sport and/or rehabilitation device, outputting a signal.

18. The method as claimed in claim 17, wherein
the first sport and/or rehabilitation device has an electric drive, and
the open-loop control and/or the closed-loop control is used for open-loop and/or closed-loop control of the drive.

19. The method as claimed in claim 17, wherein the first communication connection is established by a communication application on the HMI.

20. The method as claimed in claim 19, wherein
at least one of the application for observation and/or operation of the first sport and/or rehabilitation device and the communication application is transmitted by the first sport and/or rehabilitation device to the HMI, from a separate memory or from the Internet.

21. The method as claimed in claim 17, wherein the application for observation and/or operation of the first sport and/or rehabilitation device is transmitted by the first sport and/or rehabilitation device to the HMI, from a separate memory or from the Internet.

22. The method as claimed in claim 17, wherein the first sport and/or rehabilitation device checks the HMI or its user with regard to authorization for observation and/or operation.

23. The method as claimed in claim 17, wherein
the HMI, before the first communication connection is established, contacts a plurality of sport and/or rehabilitation devices,
only a chosen sport and/or rehabilitation device responds to the HMI after being contacted, and
the HMI establishes the first communication connection only with the chosen sport and/or rehabilitation device.

24. The method as claimed in claim 17, wherein location data is transmitted from the HMI to the first sport and/or rehabilitation device.

25. The method as claimed in claim 17, wherein the HMI is used as a gateway to the first sport and/or rehabilitation device such that another device communicates with the first sport and/or rehabilitation device via the HMI.

26. The method as claimed in claim 17, wherein information relating to the first sport and/or rehabilitation device is displayed on the HMI at predeterminable times.

27. The method as claimed in claim 17, wherein information relating to the first sport and/or rehabilitation device is displayed on the HMI only at predetermined times.

28. The method as claimed in claim 17, wherein an optical and/or acoustic warning signal is output at the HMI for a critical state of the first sport and/or rehabilitation device or a critical state of a user of the first sport and/or rehabilitation device.

29. The method as claimed in claim 17, wherein the HMI is supplied with electrical energy by the first sport and/or rehabilitation device.

30. An open-loop control and/or closed-loop control system for sport and/or rehabilitation devices, comprising:
at least one interface to establish first and second communication connections, the first communication connection being between a Human Machine Interface (HMI) and a first sport and/or rehabilitation device, the HMI being a device selected from the group consisting of smartphones, navigation devices, digital picture frames and tablet personal computers, the second communication connection being from the HMI to a second sport and/or rehabilitation device for observation and/or operation of the second sport and/or rehabilitation device, the second communication connection being directly from the HMI to the second sport and/or rehabilitation device or indirectly from the HMI to the second sport and/or rehabilitation device via a further HMI assigned to the second sport and/or rehabilitation device; and
a processor to:
identify the HMI at the first sport and/or rehabilitation device;
check, at the first sport and/or rehabilitation device, whether the HMI is suitable for observation and/or operation of the first sport and/or rehabilitation device;
to permit the HMI to observe and/or operate the first sport and/or rehabilitation device via an application on the HMI, if the HMI is suitable for observation and/or operation of the first sport and/or rehabilitation device;
to send and/or receive data via the second communication connection and perform a benchmark comparison between the first and second sport and/or rehabilitation devices; and
to cause a signal output if the HMI is not being suitable for observation and/or operation of the first sport and/or rehabilitation device.

31. A non-transitory computer readable storage medium storing a program which when executed by a computer processor causes the computer processor to perform an open-loop and/or closed-loop control method for a first sport and/or rehabilitation device, the method comprising:
establishing a first communication connection between a Human Machine Interface (HMI) and a first sport and/or rehabilitation device, the HMI being a device selected from the group consisting of smartphones, navigation devices, digital picture frames and tablet personal computers;
identifying the HMI at the first sport and/or rehabilitation device;
checking, at the first sport and/or rehabilitation device, whether the HMI is suitable for observation and/or operation of the first sport and/or rehabilitation device;
permitting the HMI to observe and/or operate the first sport and/or rehabilitation device via an application on the HMI, if the HMI is suitable for observation and/or operation of the first sport and/or rehabilitation device;
exchanging data with a second sport and/or rehabilitation device, the data being exchanged via a second communication connection from the HMI to the second sport and/or rehabilitation device using the HMI as a gateway, the data being exchanged to perform a benchmark comparison between the first and second sport and/or rehabilitation devices; and
causing a signal output if the HMI is not being suitable for observation and/or operation of the first sport and/or rehabilitation device.

32. A non-transitory computer readable storage medium storing a program which when downloaded by and executed on a Human Machine Interface (HMI), performs a method for comparing first and second sport and/or rehabilitation devices, the HMI being a device selected from the group consisting of smartphones, navigation devices, digital picture frames and tablet personal computers, the method comprising:
connecting the HMI and the first sport and/or rehabilitation device via a first communication connection;
performing open-loop and/or closed-loop control of the first sport and/or rehabilitation device after the HMI is checked and approved by the first sport and/or rehabilitation device, the open-loop and/or closed-loop control being performed via the first communication connection between the HMI and the first sport and/or rehabilitation device;
setting up a second communication connection from the HMI to a second sport and/or rehabilitation device for observation and/or operation of the second sport and/or rehabilitation device, the second communication connection being directly from the HMI to the second sport and/or rehabilitation device or indirectly from the HMI to the second sport and/or rehabilitation device via a further HMI assigned to the second sport and/or rehabilitation device;
performing a benchmark comparison between the first and second sport and/or rehabilitation devices; and
outputting a signal if the first sport and/or rehabilitation device determines that the HMI is not suitable for observation and/or operation of the first sport and/or rehabilitation device.
